(19) United States
(12) Patent Application Publication
(10) Pub. No.: US 2026/0084536 A1
(43) Pub. Date: Mar. 26, 2026

(54) Magnetic Brake Mitigation Module for Lightweight Electric Vehicles

(71) Applicant: Inventus Power, Inc., Woodridge, IL (US)

(72) Inventors: William Tenorio, Glenview, IL (US); Kaleb P. Vicary-Rzab, Crete, IL (US)

(21) Appl. No.: 19/404,174

(22) Filed: Dec. 1, 2025

Related U.S. Application Data
(63) Continuation of application No. PCT/US2024/032029, filed on May 31, 2024.
(60) Provisional application No. 63/471,288, filed on Jun. 6, 2023.

(51) Int. Cl. B60L 3/00; B60L 7/28

(52) U.S. Cl. CPC B60L 3/0046; B60L 3/0076; B60L 7/28; B60L 2240/547

(57) ABSTRACT

A magnetic brake mitigation module is described. During a catastrophic failure of a power supply, magnetic brakes are designed to quickly bring an electric vehicle to a stop. In some electric vehicles with minimal safety systems (e.g., seatbelts or doors), the abrupt stop can be unsafe. The magnetic brake mitigation module determines when a catastrophic failure has occurred and supplies, for a short period, stored power to the magnetic brakes to prevent a maximum braking force from being applied to the wheels.

### RELATED APPLICATIONS

This application is a bypass continuation of PCT/US2024/032029, entitled “Magnetic Brake Mitigation Module for Lightweight Electric Vehicles”, filed May 31, 2024, which claims priority to U.S. Provisional Patent Application No. 63/471,288, entitled “Magnetic Brake Mitigation Module for Lightweight Electric Vehicles”, filed Jun. 6, 2023. The entireties of the contents of these applications are incorporated by reference herein for all purposes.

### TECHNICAL FIELD

The disclosure relates generally to electric vehicles. More particularly, the disclosure relates to braking systems of electric vehicles.

### BACKGROUND

In certain vehicles, magnetic brakes require electrical power to remain disengaged. These brakes are often a failsafe braking system in which, upon failure of the power system (e.g., loss of all electrical power), the brakes engage to bring the vehicle to a full stop. Magnetic brakes often function by requiring electrical power to keep them from engaging with wheels' rotors. When electrical power is lost, the magnetic brakes will engage. For instance, at rest, a magnetic braking system may prevent rotations of wheels where magnetic plates are attracted to rotors. When an electromagnetic coil is energized, the coil may force the plates to separate from the rotors to permit rotation of the wheels. In other situations, some braking systems may use strong springs to bias disks against the rotors to prevent rotation of the wheels. When energized, the electromagnetic coils may force the disks away from the rotors to permit the wheels to rotate.

Also, other magnetic braking systems are based on electromagnetic induction. When a magnetic field is applied to a conductor (in this case, a rotating disc or drum attached to the wheel), it induces eddy currents in the conductor. These currents generate their own magnetic field which opposes the original magnetic field, creating a braking force. In other words, these eddy currents generate their own magnetic field, which opposes the original magnetic field.

In lightweight electric vehicles, the braking system—including magnetic brakes—may impart substantial braking forces compared to the mass of the electric vehicles such that full engagement of the magnetic brakes may result in a sudden and abrupt stop. As some lightweight electrical vehicles including electric golf carts lack seat belts and full enclosures, passengers may be tossed about the vehicles or thrown from them when magnetic brakes lock up unexpectedly. Further, full engagement of the magnetic brakes removes control of the vehicle from the user as the user is unable to gently slow down the vehicle but is forced to fight for control during an abrupt stop. This situation is unsafe for the driver and passengers as well as the electric vehicle itself as the timing of when the vehicle decides to stop is unknown. The vehicle may stop in the middle of a busy road or while crossing in front of other vehicles. Thus, a need exists to address abrupt stops caused by loss of power.

### SUMMARY

A magnetic brake mitigation module (MBMM) is disclosed herein. The disclosed MBMM addresses the sudden braking force of magnetic braking systems to permit the driver to control the vehicle as the vehicle is gradually brought to a stop. The power provided by the MBMM to the magnetic brakes may be provided using novel hardware, software, firmware, circuitry, and/or combination thereof designed for a fixed or universal MBMM with integration into a battery pack or as a standalone device.

One primary problem being solved by this disclosure involves unintelligent/dummy electric vehicles (e.g., golf carts and other lightweight, human-ridden vehicles) that lack sophisticated/expensive vehicle control modules (VCMs) and/or dynamic adjustment mechanisms, but for which passengers still desire a way to prevent an undesirable, abrupt stop. For example, intelligent/sophisticated/expensive golf carts often have VCMs and dynamic adjustment mechanisms that very basic (e.g., dummy) golf carts do not. The intelligent golf carts use their VCMs and other features to coast the golf cart down at a safe rate of reduction in velocity, thus avoiding an undesired, abrupt stop. Meanwhile, dummy golf carts provide more stop-and-go operations.

For purposes of a simplified explanation, the disclosure herein references golf carts, but is not meant to be so limited. Rather, golf carts can be replaced by any electric vehicle with a magnetic braking system that can benefit from the advantages disclosed herein.

Moreover, traditional electric-powered golf carts are powered by rechargeable lead-acid batteries. Lead acid batteries in electric-powered golf carts allow drivers to drive down hills such that the golf carts would eventually coast down but without necessarily cutting off battery power from the lead acid batteries. In other words, those golf carts would continue to have a terminal voltage across the secondary/rechargeable battery leads. In contrast, when electric-powered golf carts operate with a lithium-ion battery/battery pack, the battery protection circuitry in some golf carts will shut off the Li-Ion battery to protect the Li-Ion battery cells when the golf cart is coasting. Once that terminal voltage decreases to zero (or falls below a threshold), the golf cart loses power. Some Li-Ion-powered vehicles come to an abrupt, complete, and potentially dangerous stop. On some electric motors with magnetic disc braking systems attached to them, when a vehicle turns ON, the magnetic brakes open and the vehicle is able to freely move. However, if there is no electrical energy from the battery, the magnetic brake will engage and clamp to the rotor or other parts of the wheels such that the EV is immobilized. As a result, the wheels lock up, and the EV is brought to an abrupt stop while also preventing the EV from moving until power is restored.

These features, along with many others, are discussed in greater detail below.

### BRIEF DESCRIPTION OF DRAWINGS

The present disclosure is illustrated by way of example and not limited to the accompanying figures in which like reference numerals indicate similar elements and in which:

FIG. 1 is a flowchart describing when a magnetic brake mitigation module engages and disengages;

FIG. 2 is another flowchart describing when a magnetic brake mitigation module engages and disengages;

FIG. 3 shows an example of the magnetic brake mitigation module separate from the batteries of a vehicle;

FIG. 4 shows an example of the magnetic brake mitigation module integrated with a battery system of a vehicle;

FIG. 5 shows an example of the magnetic brake mitigation module integrated with a battery control system of a vehicle; and

FIG. 6 shows an example of the magnetic brake mitigation module.

### DETAILED DESCRIPTION

A magnetic brake mitigation module is described. During a catastrophic failure of a power supply, magnetic brakes are designed to quickly bring an electric vehicle to a stop. In some electric vehicles with minimal safety systems (e.g., seatbelts or doors), the abrupt stop can be unsafe. The magnetic brake mitigation module determines when a catastrophic failure has occurred and supplies, for a short period, stored power to the magnetic brakes to prevent a maximum braking force from being applied to the wheels.

In the following description of the various embodiments, reference is made to the accompanying drawings, which form a part hereof, and which are shown by way of illustration of various embodiments in which aspects of the disclosure may be practiced. It is to be understood that other embodiments may be utilized, and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. Any sequence of computer-implementable instructions described in this disclosure may be considered to be an “algorithm” as those instructions are intended to solve one or more classes of problems or to perform one or more computations.

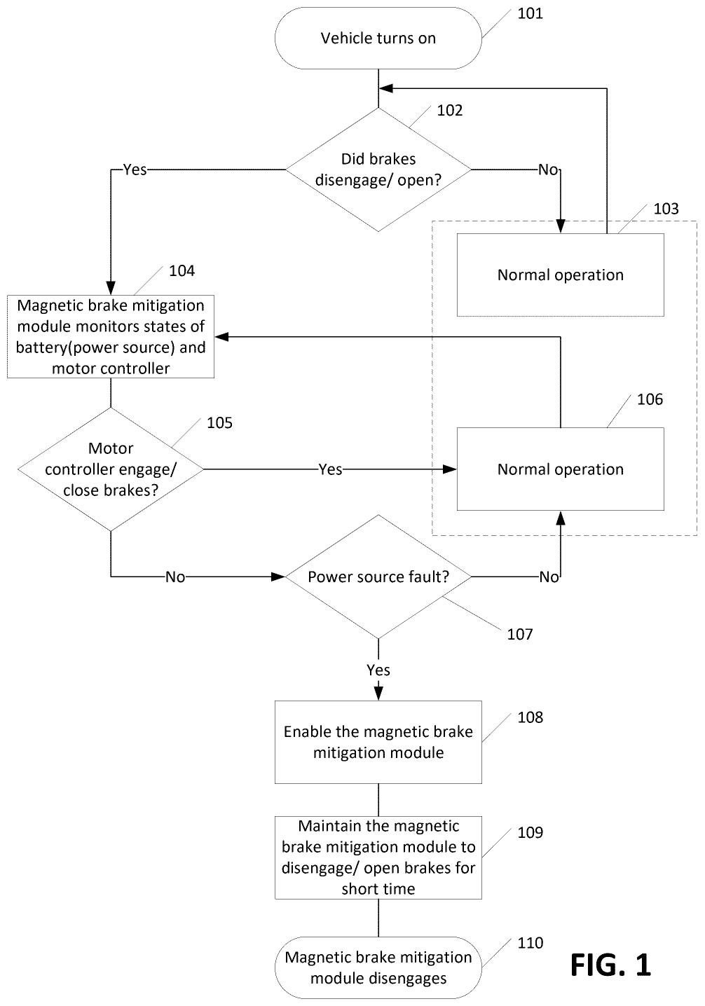

In the example of FIG. 1 and the other examples described herein, the magnetic brake mitigation module is described with reference to an electronic vehicle capable of being turned on and off. This is for explanatory purposes. Aspects of the disclosure are intended, unless otherwise specified, to encompass vehicles that do not have an OFF state per se but may include a sleep state or low power consumption state. Also, various examples relate to electric vehicles that are only powered by electricity. Again, this is for explanatory purposes. Aspects of the disclosure are intended, unless otherwise specified, to vehicles with magnetic brakes regardless of the power source or combination of power sources of vehicles. Further, various examples relate to vehicles that automatically engage their brakes when not moving. This is for explanatory purposes. Aspects of the disclosure are intended, unless otherwise specified, to vehicles that do not automatically engage their brakes in all situations. For instance, when coasting to a stop where drivers remove their feet from accelerator pedals, some vehicles may not automatically engage their brakes after stopping. For purposes of explanation, brakes are described as being “engaged” or “closed”. With respect to the brakes, these terms are intended to encompass at least being engaged through completely locking closed the brakes. Also, for purposes of explanation, brakes are described as being “disengaged” or “opened”. With respect to the brakes, these terms are intended to encompass at least the braking force being decreased to the brakes no longer applying any braking force to the wheels.

FIG. 1 is a flowchart describing an example process controlling when a magnetic brake mitigation module engages and disengages. Referring to FIG. 1, the method disclosed solves the aforementioned problem without requiring the vehicle to have been built with expensive VCMs, controls, or other components. Aspects of the disclosed solution also work to retrofit unintelligent/dummy electric vehicles with an external device that is mounted/installed in the electric vehicle or that is integrated into an existing component such as a battery or other component. The disclosed system allows the EV to safely coast to a complete stop—i.e., without the abrupt stop that typically occurs when a dummy EV with a Li-ion battery or array of Li-ion batteries notices the Li-ion battery has been shut off and the resulting terminal voltage drops or is at zero volts.

In one embodiment, the example flowchart in FIG. 1 discloses steps performed by a system that includes at least a battery, a magnetic brake, and a sensors/measurement unit. A magnetic brake mitigation module may be connected to battery terminals and include one or more sensors to determine a voltage across the battery terminals. The magnetic brake mitigation module may measure an actual voltage or more simply determine whether the voltage has dropped below a threshold. Also, the magnetic brake mitigation module may be connected to the magnetic braking system.

As FIG. 1 illustrates, a vehicle is turned on in step 101. The magnetic brake mitigation module monitors a motor controller and/or a voltage across battery terminals. In the case of brakes that EVs that have brakes that automatically engage when idling (e.g., a simple golf cart), the magnetic brake mitigation module may determine, in step 102, whether initially engaged brakes have been disengaged or opened. If the brakes have not been disengaged or opened, the magnetic brake mitigation module moves to step 103, identifying the magnetic brake mitigation module is in a normal operation mode where the magnetic brake mitigation module: A. does not change the state of the brakes and B. continues to monitor the vehicle for whether the brakes have been disengaged.

If the brakes have been disengaged (as determined in step 102), then in step 104 the magnetic brake mitigation module monitors the states of the power source (e.g., battery or battery array or other power source) and the motor controller. In step 105, the magnetic brake mitigation module determines whether the motor controller has controlled the brakes to begin slowing the vehicle. If the magnetic brake mitigation module determines that the motor controller has engaged the brakes, then in step 106 the magnetic brake mitigation module permits the brakes to operate in the normal operation mode. The normal operation modes 103 and 106 may be the same (shown by the dashed box encompassing both normal operation modes 103 and 106) in which the magnetic brake mitigation module does not interfere with the current state of the brakes. Alternatively, they may be different normal states such that normal operation mode 103 waits for the brakes to be disengaged before starting to monitor the state of the brakes, power source, and/or motor controller while normal operation mode 106 may continue to monitor the state of the brakes, power source, and/or motor controller regardless of whether the brakes have been disengaged.

If the magnetic brake mitigation module determines in step 105 that the motor controller did not engage the brakes, the magnetic brake mitigation module determines whether the power source (e.g., the battery or array of batteries in a pack or other power supply (e.g., capacitors and/or inductors) has suffered a fault (e.g., a failure to continue to provide power across power terminals). If the power source did not suffer a fault as determined in step 107, then the magnetic brake mitigation module operates to the normal operation mode 106 (and continues to monitor the states of the power source and motor controller in step 104, determine whether the motor controller has engaged the brakes in step 105 and whether the power source suffered a fault in step 107.

If the power source suffered a fault as determined in step 107, the magnetic brake mitigation module is engaged in step 108. Next, in step 109, the magnetic brake mitigation module provides power to the magnetic brakes for a short time to disengage/open the brakes (e.g., reduce braking force). After a short time, the magnetic brake mitigation module stops providing sufficient power to the magnetic brakes in step 110 and the brakes close, preventing further rotation of the wheels.

In one or more examples, the magnetic brake mitigation module may include its own power source (e.g., a power bank or other power source—for instance, a capacitor). The magnetic brake mitigation module, when enabled in step 108, may output an electrical current to the magnetic brakes in step 109 to disengage/keep open the magnetic brakes for an amount of time. In some embodiments, the amount of time depends on the amount of charge residing in the power bank (e.g., supercapacitor bank). In other embodiments, the amount of time may be the lesser of the aforementioned time or the lapse of a predetermined amount of time (e.g., 30 seconds, a time duration shorter than 30 seconds, or a time duration longer than 30 seconds) desirable for gradually slowing the vehicle to a stop. In yet other embodiments, the predetermined amount of time may be substituted with a dynamically calculated amount of time dependent on the current speed of the vehicle such that, if the vehicle is traveling at a high speed, the length of time may be a longer duration to accommodate for a gradual slowing of the vehicle to bring it to a complete stop.

The magnetic brake mitigation module monitors the battery and the magnetic brake system to control the state of the magnetic brake mitigation module. The states/modes of operation of the magnetic brake mitigation module may include but are not limited to: (1) active, (2) standby-active, (3) standby-inactive, (4) charging, and/or other appropriate states. In an active state, the device may be charged, discharge conditions are met, and the discharge circuit is enabled. In a standby-active state, the device may be charged and the magnetic brake is active. In a standby-inactive state, the device may be charged and the magnetic brake is inactive. In a charging state, the device may be charging, and discharge conditions are not met.

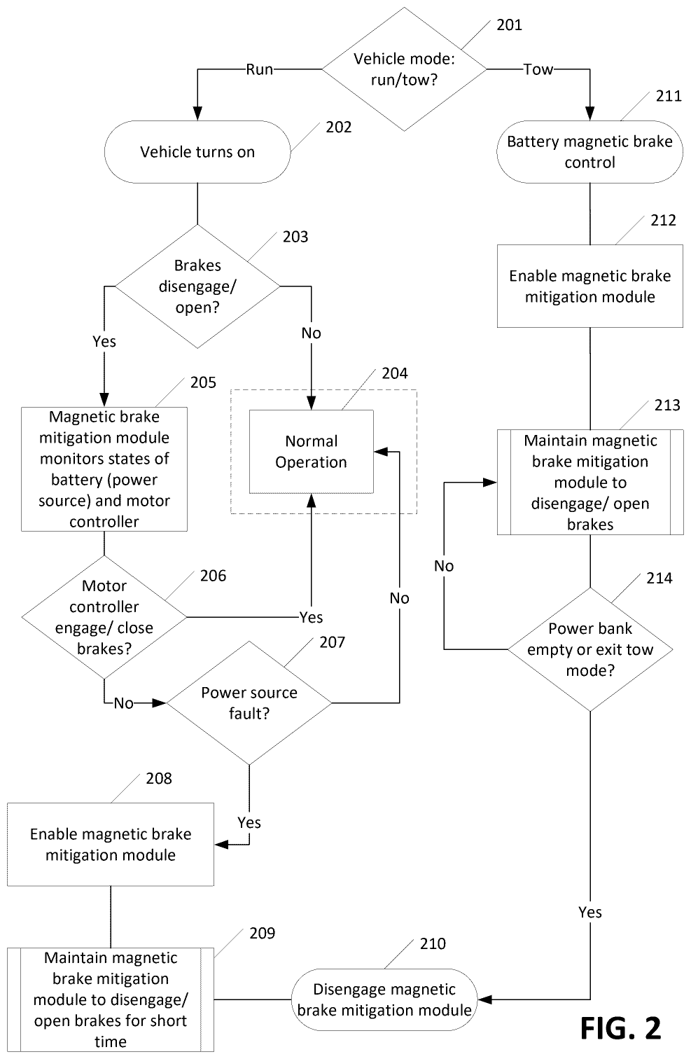

FIG. 2 is another flowchart describing a process during which a magnetic brake mitigation module may be engaged. Referring to FIG. 2, in addition to a hypothetical use case involving a golf cart coasting, another use case involves the towing (or manually pushing) of a golf cart. The disclosed embodiments herein contemplate overriding the typical operation of a magnetic braking system in two or more modes: (1) coasting mode; (2) towing mode; and (3) other mode(s).

In a towing mode, in contrast to potential prior art systems where a driver might be required to pull/redirect an electrical connector or other wiring/components under the hood of an EV, the solution described herein provides an elegant, user-friendly solution that does not require the electrical or mechanical expertise to operate. For example, some prior art systems go so far as to require a lay user to open the hood of an EV and potentially swap wires/connectors into another section to allow the bypass of the magnetic braking system so that the EV may be pushed or towed.

In step 201, the magnetic brake mitigation module may determine whether the vehicle is in a run mode or a tow mode. If the vehicle is determined, in step 201, to be in the tow mode, the magnetic brake mitigation module may be enabled as shown in step 211. For instance, the electric vehicle may enter tow mode because a user toggles a tow switch ON. The magnetic brake mitigation module may include a connector (e.g., a tow switch connector) to allow for the magnetic brake mitigation module to connect to the vehicle's TOW switch. In some embodiments, the TOW switch might be removed where the operation of the magnetic brake mitigation module is driven by the battery pack with an integrated magnetic brake mitigation module and not a separate magnetic brake mitigation module. Similar to the illustrative use case described with respect to FIG. 1, a power bank or other power source (e.g., capacitor) controlled by the magnetic brake mitigation module may maintain an electrical current to the magnetic brake to disengage/keep open the magnetic brake for an amount of time, which might be a dynamic amount of time depending on the amount of charge residing in the power bank, a predetermined amount of time (e.g., 30 seconds, or other time duration), or a dynamically calculated amount of time dependent on one or more factors.

As shown in FIG. 2, following entering the battery magnetic brake control in step 211, the magnetic brake mitigation module may be engaged in step 212 (e.g., the magnetic brake mitigation module may be allowed to control the state of the brakes as needed). In step 213, the magnetic brake mitigation module may provide power to disengage the brakes and keep them disengaged. In step 214, the magnetic brake mitigation module determines whether its power bank is empty (unable to keep the brakes disengaged) or whether the vehicle has exited the TOW mode. If both the power bank has sufficient charge and the vehicle is still in the TOW mode, then in magnetic brake mitigation module continues to provide power to the brakes in step 212 to keep them disengaged. If either the power bank no longer has sufficient charge and/or the vehicle has been switched out of the TOW mode, then in step 210, the magnetic brake mitigation module is disengaged from controlling the brakes.

If, in step 201, the vehicle is in a standard RUN mode and not in the TOW mode, then the vehicle turns on in step 202. In step 203, the magnetic brake mitigation module determines whether the brakes have been disengaged. If the brakes have not been disengaged, then the magnetic brake mitigation module operates in a normal mode 204. As described in FIG. 1, the normal mode 204 may comprise a single or different types of normal modes during which the magnetic brake mitigation module does not control the state of the brakes. This single or different types of normal modes is shown by the dashed box surrounding the normal mode 204.

If the magnetic brake mitigation module determines that the brakes have been disengaged in step 204, the magnetic brake mitigation module monitors the states of the power source (e.g., battery or battery pack) and the motor controller. In step 206, the magnetic brake mitigation module determines whether the motor controller has controlled the brakes to engage. If the magnetic brake mitigation module determined in step 206 that the motor controller controlled the brakes to engage, the magnetic brake mitigation module operates in the normal mode of step 204. If the magnetic brake mitigation module determined in step 206 that the motor controller did not control the brakes to engage, the magnetic brake mitigation module determines in step 207 whether the power source experienced a fault (e.g., decreased power from a battery pack). If the magnetic brake mitigation module determines in step 207 that there was no power source fault, then the magnetic brake mitigation module operates in the normal mode of step 204. If the magnetic brake mitigation module determines in step 207 that there was a power source fault, then the magnetic brake mitigation module is enabled in step 208 to control the state of the brakes. In step 209, the magnetic brake mitigation module maintains the brakes open (e.g., disengages them) for a short period of time. After the short period of time, the magnetic brake mitigation module is disengaged from controlling the brakes in step 210.

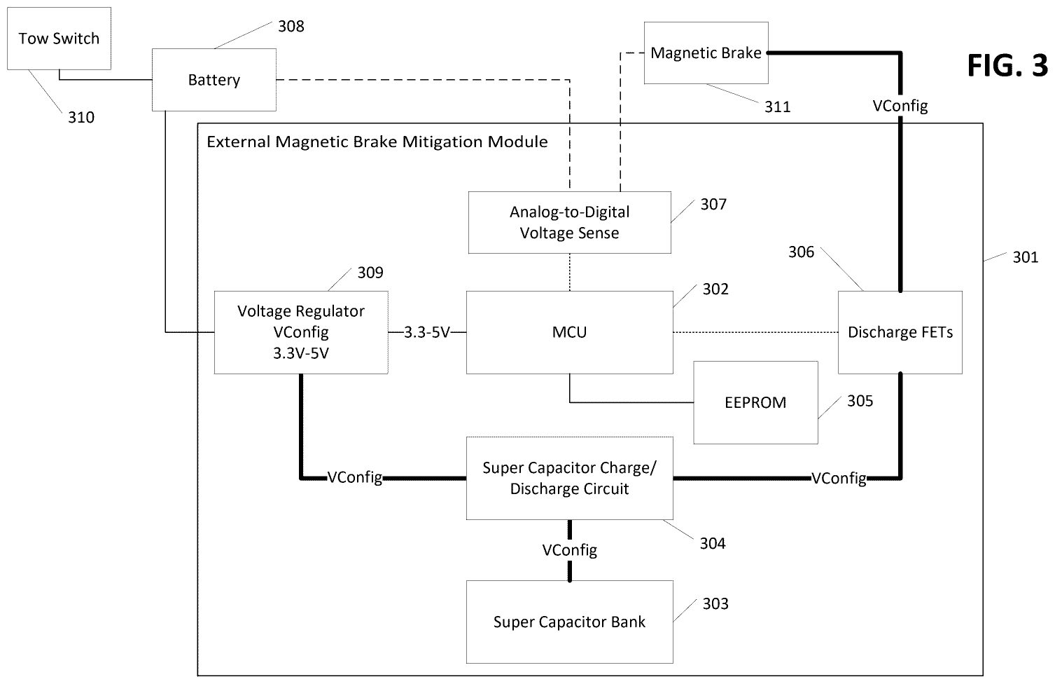

FIG. 3 shows an example of the magnetic brake mitigation module 301 separate from the battery or battery pack (e.g., a power supply) 308 of a vehicle. The standalone magnetic brake mitigation module may also be separate from the magnetic brake 311. The magnetic brake mitigation module may be used, for instance, in lightweight dummy electric vehicles (e.g., golf cars).

The magnetic brake mitigation module 301 may receive inputs from both the battery 308 and the magnetic brake 311 as shown in FIG. 3. An analog-to-digital voltage converter (e.g. A/D voltage sense unit 307) may receive a voltage across the magnetic brake 311, which in some embodiments, may be zero to 56 volts (or some other voltage range). The A/D voltage sense unit 307 converts the analog voltage level into a digital signal that is input into a motor controller unit (MCU) 302 to cause a voltage regulator 309 and/or discharge field-effect transistors (FETs) or MOSFETs 306 to react accordingly. The discharge FETs or MOSTFETs 306 are an example of a power switching circuit. Other types of semiconductors may be used. In addition, the voltage across the terminals of the battery/battery pack 308 is also an input to the magnetic brake mitigation module 301. In some embodiments, a tow switch 310 may override this input when the user desires to tow/push the vehicle with the magnetic brake 311 open (e.g., not locked).

The magnetic brake mitigation module 301 may monitor voltages across the magnetic brake 311 and the battery 308 by converting the voltage levels into digital signals via the A/D converter 307 (shown as Analog-to-Digital Voltage Sense 307). The digital signals may be analyzed by the motor control unit (e.g., a hardware controller configured to monitor input voltage levels and selectively control the operation of the discharge FETs 306).

For example, power from the battery 308 may be provided to the voltage regulator 309. The voltage regulator 309 may output a configuration voltage (here, VConfig) and optionally a separate voltage in the range of 3.5 V to 5 V. The separate voltage of 3.5 V to 5 V may power the MCU 302 and other components of the magnetic brake mitigation module 301. The VConfig voltage may be provided to a supercapacitor charge/discharge circuit 304 to provide power to charge a bank of capacitors (e.g., supercapacitors or other power storage) 303. When controlled by the MCU 302, the supercapacitor charge/discharge circuit 304 may provide a voltage from the supercapacitor bank 303 to the discharge FETs 306. When controlled by the MCU 302, the discharge FETs 306 may provide power to the magnetic brake 311 to keep it from engaging. As the power provided by the supercapacitor bank 303 is not infinite, the power provided to the magnetic brake 311 from the discharge FETs 306 will eventually run out-either by the power available from the supercapacitor bank 303 being depleted or the discharge FETs 306 being turned off to stop current flowing to the magnetic brake 311.

The magnetic brake mitigation module 301 may provide a magnetic brake reserve capacity. In the instance in which a standalone magnetic brake mitigation module 301 provides power and then stops, it is possible to keep a fixed reserve capacity within the battery pack 308 and/or the supercapacitor bank 303 to allow for a separate signal to drive that energy out of the battery pack 308 and/or the supercapacitor bank 303. For instance, some vehicles have a tow switch 310. This tow switch 310 may drive a signal to the battery pack 308, which, in turn, would enable the magnetic brake mitigation module 301's power output to allow easy movement of the vehicle for the time possible as provided by the reserved capacity of either the battery pack 308 and/or the supercapacitor bank 303.

The magnetic brake mitigation module 301 may allow full energy utilization. The magnetic brake mitigation module 301 may allow the vehicle to increase range or maximize the utilization of all available power by adding an energy storage device (the supercapacitor bank 303 or in addition to the supercapacitor bank 303). For instance, this storage device can be another supercapacitor or another (secondary/rechargeable) battery. In some embodiments, the magnetic brake mitigation module 301 keeps the added energy storage device energized when necessary/desirable, so that when/if the battery cuts off, the magnetic brake mitigation module 301 provides independent power from the added energy storage device to the magnetic brake 311. This then allows the electric vehicle to drive the battery 308 down further as compared to the utilization of a straight unregulated output. Some power specifications of the system include but are not limited to the following as shown in Table 1:

TABLE 1
Power
Specifications

| | |
|---|---|
| Device Input | MBMM is powered by an input voltage between |
| Voltage | 9 V-60 V (or other voltage that is greater or lesser) |
| Super | MBMM outputting of 12 V, 24 V, 36 V, or 48 V at 3 A |
| Capacitor | for 30 seconds using supercapacitors (other output |
| Bank | power that is greater or lesser) |
| Output | MBMM outputting a regulated 12 V, 24 V, 36 V, or 48 |
| Voltage | V output, (or other voltage that is greater or lesser) |
| Output | MBMM outputting 3 A peak and 500 mA continuous |
| Current | output (or other power that is greater or lesser) |
| Quiescent | Current may be driven by component selection |
| (inactive state) | |

Some overcurrent protection specifications of the system include but are not limited to the following as shown in Table 2:

TABLE 2
Overcurrent
Protection

| | |
|---|---|
| Device | MBMM may safely accept up to 3 A of current, in some |
| Input | embodiments. When more than 3 A of current is passed |
| Voltage | to the device, the device may be protected by overcurrent |
| | circuitry, as illustrated by the voltage regulator 309 in |
| | FIG. 3. Exceeding this threshold may result in a |
| | permanent failure |
| Device | MBMM may operate safely from an input voltage up to |
| Input | 65 V, in some embodiments. When a voltage higher than |
| Voltage | 65 V is received, the device may be protected from |
| | overvoltage circuitry, as illustrated by the voltage |
| | regulator 309 in FIG. 3. Exceeding this threshold may |
| | result in a permanent failure |

The magnetic brake mitigation module 301 may further include a memory, shown in FIG. 3 as an EEPROM 305. Although FIG. 3 is illustrated with the EEPROM 305, in some embodiments, the EEPROM 305 may be optional and/or substituted for a different rewritable non-volatile memory. The EEPROM 305's stored voltage configurations may be 12V, 24V, 36V, and/or 48V configurations. The stored voltage configurations may comprise one or more mapping tables identifying, for different manufacturers or types of vehicles, voltage ranges for magnetic brakes, threshold values for those ranges, and possible output voltage values to be applied to the magnetic brakes.

The (optional) EEPROM 305 may be pre-programmed with values to accommodate different manufacturers' lightweight electric vehicles' operational parameters. As a result, a single, standalone magnetic brake mitigation module 301 may be manufactured and sold to all golf cart manufacturers as universal and ready-to-use.

In some examples, a threshold voltage at which the magnetic brake mitigation module 301 assumes control of the magnetic brakes 311 may be fixed. In other examples, the threshold voltage may be adjustable (and thus universal). The magnetic brake mitigation module's 301 hardware and firmware may support, in some embodiments, a straight passthrough of an unregulated battery cell stack voltage making for a fixed system implementation. This means that a 48V battery with a separate unregulated output voltage may serve as the power source for a magnetic brake 311. In that example, the main power path of the battery pack cuts off power well before the unregulated output to help ensure the magnetic brake 311 is still powered and not engaged. The same would apply to a 36V, 24V, 12V, or a higher voltage (>60V) system.

A universal magnetic brake mitigation module 301 would take a wide input voltage range and configure the output to match the magnetic brake parameters. In that example, the magnetic brake 311 does not need to match the overall system voltage to allow vehicles to use the same magnetic brake 311 across all vehicle platforms. The EEPROM 305 in the universal magnetic brake mitigation module 301 would be programmed with the desired magnetic brake configurations and connected to the vehicle.

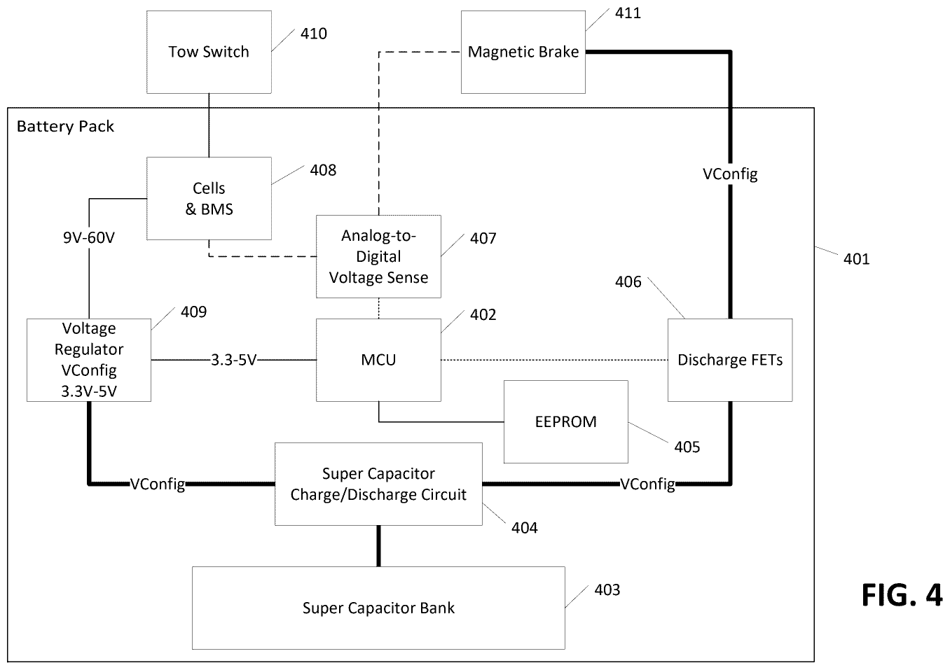

FIG. 4 shows an example of the magnetic brake mitigation module integrated with a battery system of a vehicle. Referring to FIG. 4, an illustrative embodiment is shown in which a magnetic brake mitigation module of FIG. 3 is integrated into a battery pack 401. As a result, the magnetic brake mitigation module does not need an external input for the voltage across the battery terminals. The magnetic brake mitigation module would still receive communications from and to the magnetic brake, as explained with reference to FIG. 3 and generally herein.

For example, as shown in FIG. 4, inputs from battery cells and/or a battery management system 408 and a magnetic brake 411 may be received by an analog-to-digital voltage converter (e.g. A/D voltage sense unit 407). The A/D voltage sense unit 407 may receive a voltage across the magnetic brake 411, which in some embodiments, may be zero to 56 volts (or some other voltage range). The A/D voltage sense unit 407 converts the analog voltage level into a digital signal that is input into a motor controller unit (MCU) 402 to cause a voltage regulator 409 and/or discharge field-effect transistors (FETs) 406 to react accordingly. In addition, the voltage across the terminals of the batteries or battery management system 408 is also an input to the magnetic brake mitigation module 402. In some embodiments, a tow switch 410 may override this input when the user desires to tow/push the vehicle with the magnetic brake 411 open (e.g., not locked).

The MCU 402 of the magnetic brake mitigation module in the battery pack 401 may monitor voltages across the magnetic brake 411 and the battery/BMS 408 by converting the voltage levels into digital signals via the A/D converter 407 (shown as Analog-to-Digital Voltage Sense 407). The digital signals may be analyzed by the motor control unit 402.

For example, power from the battery/BMS 408 may be provided to the voltage regulator 409. The voltage regulator 409 may output a configuration voltage (here, VConfig) and optionally a separate voltage in the range of 3.5 V to 5 V. The separate voltage of 3.5 V to 5 V may power the MCU 402 and other components of the magnetic brake mitigation module. The VConfig voltage may be provided to a supercapacitor charge/discharge circuit 404 to provide power to charge a bank of capacitors (e.g., supercapacitors or other power storage) 403. When controlled by the MCU 402, the supercapacitor charge/discharge circuit 404 may provide a voltage from the supercapacitor bank 403 to the discharge FETs 406. When controlled by the MCU 402, the discharge FETs 406 may provide power to the magnetic brake 411 to keep it from engaging. As the power provided by the supercapacitor bank 403 is not infinite, the power provided to the magnetic brake 411 from the discharge FETs 406 will eventually run out-either by the power available from the supercapacitor bank 403 being depleted or the discharge FETs 406 being turned off to stop current flowing to the magnetic brake 411.

The magnetic brake mitigation module in the battery pack 401 may provide a magnetic brake reserve capacity. In the instance in which an integrated magnetic brake mitigation module provides power and then stops, it is possible to keep a fixed reserve capacity within the battery/BMS 408 and/or the supercapacitor bank 403 to allow for a separate signal to drive that energy out of the battery/BMS 408 and/or the supercapacitor bank 403. For instance, some vehicles have a tow switch 410. This tow switch 410 may drive a signal to the battery/BMS 408, which, in turn, would enable the magnetic brake mitigation module's power output to allow easy movement of the vehicle for the time possible as provided by the reserved capacity of either the battery/BMS 408 and/or the supercapacitor bank 403.

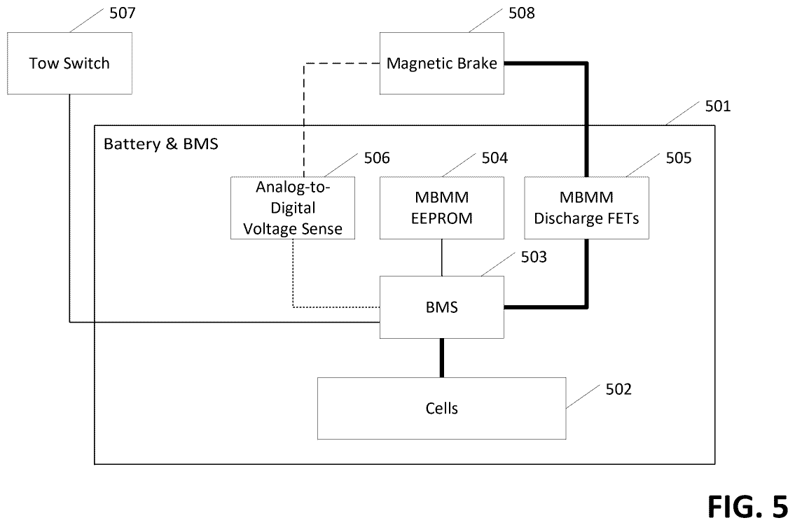

Comparing FIGS. 3 and 4, the magnetic brake mitigation module may be separate from a battery pack as shown in FIG. 3 and/or may be integrated into the battery pack as illustrated in FIG. 4. Further, it can be integrated as illustrated in FIG. 5 into a vehicle control module or a motor controller (MC). The magnetic brake mitigation module can also be used as a standalone device, as illustrated in FIG. 3. One primary benefit of having a standalone device is that it provides additional protection for the end user. During a catastrophic battery failure, for example, a standalone device would distribute the energy to keep the magnetic brake disengaged to safely bring the vehicle to a stop. This might not be possible for an integrated solution into the battery if the magnetic brake mitigation module and controls were compromised.

FIG. 5 shows an example of the magnetic brake mitigation module integrated into a combination battery and BMS. Referring to FIG. 5, in some intelligent golf carts, the magnetic brake mitigation module may be integrated into the battery management system and use the vehicle's battery. For example, FIG. 5 shows a battery & battery management system 501 including battery cells 502, a battery management system 503, a tow switch 507, a magnetic brake 508, an A/D voltage sense circuit 506, an EEPROM 504 of the magnetic brake mitigation module and discharge FETs 505 of the magnetic brake mitigation module. As shown in FIG. 5, the functions of the MCU of FIGS. 3 and 4 are provided by the battery management system 503. Further, the system of FIG. 5 may include a large resistor to take some of the energy from the magnetic brake to protect the circuitry/cells. In contrast, an unintelligent/dummy golf cart alternatively might omit such a large resistor due to expense and/or other factors.

Moreover, some illustrative embodiments of a MBMM may include one or more of the following features:
Circuit Protection: Reverse Polarity. The device shall prevent reverse polarity damage
ESD Immunity. IEC 61000 April 2 (EN 55022) to level 4: +/−8 kV contact, +/−15 kV air
Mechanical Ingress Protection. In some embodiments, the device disclosed herein may be designed to IP65/IP67 specifications.
Status indicator LEDs. In some embodiments, a hardware layout might not include status LEDs, while in others, status LEDs may be included. One illustrative example of LED color and its corresponding status indicator might be as follows as shown in Table 3:

TABLE 3

| Name | Color | Description |
|---|---|---|
| Power On | Green | The device is on and active |
| Charging | Green | Blink when the capacitor bank is charging |
| Discharging | Red | Solid red when the capacitor bank or energy |
| | | storage device is discharging |

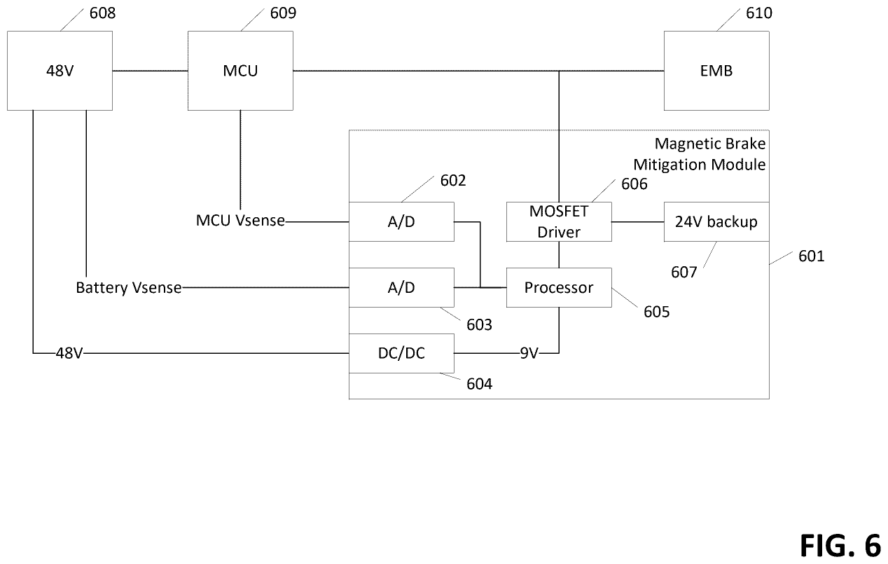

FIG. 6 shows an example of a magnetic brake mitigation module 601 separate from an electric brake motor controller unit 609. A microcontroller (e.g., a hardware processor) 605 may provide the processing functions for an illustrative magnetic brake mitigation module 601. The magnetic brake mitigation module 601 may be coupled to an emergency magnetic brake (EMB) 610, the motor controller unit (MCU) 609, and a 48V magnetic braking system 608 coupled to an electric motor (not shown for simplicity). A 24V backup secondary battery 607 provides a power supply for driving the magnetic brake mitigation module 601 to cause the braking system 610 to stay open during battery power loss/drop. A DC/DC converter 604 may provide a 9 V output to the processor 605 where the DC/DC converter 604 receives a higher voltage from the 48V magnetic braking system 608. A battery voltage sensing line is shown connecting batteries (not shown in FIG. 5) in the 48V magnetic braking system 608 to an analog-to-digital converter 603. The output of the A/D converter 603 may be passed to processor 605. Similarly, an MCU voltage sensing line may connect brake-controlling output terminals of the MCU 609 to another analog-to-digital converter 602. The output of the A/D converter 602 may be passed to processor 605 to provide a signal identifying the voltage being applied by the MCU 609 to the braking system. The magnetic brake mitigation module 601 may further include a MOSFET driver 606 controlled by the processor 605 to selectively provide voltage from the 24V backup power supply 607 to the EMB 610 as needed to prevent abrupt stops.

In some embodiments, the magnetic brake mitigation module 601 may be a standalone, external device that is harnessed/mounted in the EV using a T harness. Alternatively, the magnetic brake mitigation module 601 may be mounted in other ways to the motor, for example, using an invasive T-tap into the line. Moreover, due to space constraints, the magnetic brake mitigation module 601 might not be a simple, small printed circuit board (PCB) because it would include a power bank, such as a super-capacitor, that requires space. As a result, a mounted install may be used more frequently than other assembly methods. In some examples, the mount/integration may be done through a power distribution module (PDM) mounted in the chassis of the EV, but the secondary battery might be located outside of the PDM.

In some embodiments, there are two or more types of brakes in lightweight electric vehicles (e.g., golf carts). One is a traditional mechanical brake in which a driver steps on a pedal to set the brake. Another is where golf carts include an all-in-one system on the electric motor where a mechanism (e.g., clutch) on the motor will prevent the motor from moving because the motor is locked in place at that point. This is another embodiment of a braking system. Although the all-in-one system is a different system architecture, the modules and features described herein are applicable as appropriate.

In yet another embodiment, magnetic braking systems may work in coordination with traditional friction brakes to get the best of both braking systems. When the vehicle is moving at high speeds, the magnetic brakes can be used to efficiently slow down the vehicle. Then, as the vehicle slows and the magnetic brakes become less effective, the friction brakes can take over to bring the vehicle to a complete stop. This combination can provide smooth, efficient braking at all speeds while minimizing wear and tear on the friction brakes.

In one embodiment, the controller activates the magnetic brakes as follows. Speed sensors measure the rotational speed of the wheels. This information is continuously sent to the controller. The controller receives the speed data from the sensors. If the speed exceeds a certain limit (set according to safety standards and vehicle specifications), the controller sends a signal to activate the magnetic brakes. Magnetic brakes consist of two main components-a non-magnetic conductor (usually a metal disc or drum) attached to the wheel, and an electromagnet. The electromagnet is not in physical contact with the conductor. When the controller sends a signal, it energizes the electromagnet. When the electromagnet is energized, it creates a magnetic field. This field penetrates the rotating disc or drum (the conductor). The magnetic field induces eddy currents in the conductor. These currents create their own opposing magnetic field, which creates a braking force that slows down the rotation of the wheel. The controller continuously monitors the speed of the wheels. If the vehicle is still moving too fast, it can increase the power to the electromagnet, strengthening the magnetic field and increasing the braking force. Conversely, if the vehicle is slowing down too quickly, it can reduce the power to the electromagnet, decreasing the braking force.

The magnetic brake mitigation module allows for smooth, efficient, and wear-free braking, making it ideal for lightweight electric vehicles. However, magnetic braking systems are typically used in conjunction with traditional friction brakes for safety reasons, as they only work when the vehicle is in motion. This process depends on the conductor (the metal disk or drum) moving through the magnetic field. If the vehicle is not in motion, the conductor is not moving through the magnetic field, so no eddy currents are generated. Thus, there would be no braking force. This reason is why magnetic brakes only work when the vehicle is in motion. In practical terms, this means that magnetic brakes cannot hold a vehicle stationary on a slope, for example, because they cannot provide a braking force when the vehicle is not moving. As such, vehicles with magnetic brakes also have traditional friction brakes, which can provide a braking force whether the vehicle is moving or not.

In some embodiments, an electric vehicle may include at least the following components: a battery, a motor controller, an electric motor, wheels, magnetic brakes, and speed sensors. The battery is the power source for the vehicle. It supplies power to both the motor controller and the brake controller, when present. The motor controller manages the power supply from the battery to the motor. In some embodiments, the MC controls the motor based on user input and the data from one or more sensors. The electric motor drives the wheels of the vehicle. The magnetic brakes apply a braking force to the wheels when activated. Wheel speed sensors detect the speed of the vehicle and send this information to one or more controllers.

Alternatively, in some embodiments, an electric vehicle may further include a brake controller and user input. The brake controller (BC) controls the magnetic brakes based on user input and the data from one or more sensors. The BC commands the magnetic brakes to apply braking force to the wheels. The user input from the user, commands one or both of the MC and/or BC.

When the battery supplies power, one or more controllers (e.g., MC) control the power supply to the motor, thus driving the wheels of the EV. One or more speed sensors detect the speed of the vehicle and send this information to one or more controllers (e.g., BC). When the battery voltage falls below a threshold or to zero, the BC may engage the magnetic brakes, which apply a braking force to the wheels, slowing down the vehicle. However, before the BC causes the magnetic brakes to engage, the MBMM provides, in one embodiment, an override signal to the magnetic brakes to prevent the magnetic brakes from abruptly engaging. The MBMM gradually activates the magnetic brakes, which apply a braking force to the wheels, gradually slowing down the EV without forcing an abrupt stop. FIG. 6 is a simplified diagram and does not include each and every component of a magnetic braking system, but suffices in combination with the entirety of the disclosure herein to enable a person of skill in the art to understand how to make and use the disclosed solution without undue experimentation.

Various examples of the disclosed system may include the following. An apparatus comprising an analog-to-digital converter configured to be attached to a battery and output a first digital signal representing a voltage across battery terminals of the battery; a power storage device; a voltage regulator configured to receive power from the battery and output power to the power storage device; a power switching circuit configured to receive power from the power storage device and output power to a magnetic brake of an electric vehicle; and a hardware controller configured to: receive the first digital signal; determine, based on the digital signal, whether the voltage across the battery terminals is below a first threshold; and control, based on a determination that the voltage across the battery terminals is below the first threshold, the power switching circuit to transmit power to the magnetic brake.

The analog-to-digital converter may be further configured to receive a voltage being applied to the magnetic brake and output a second digital signal representing the voltage being applied to the magnetic brake. The determination by the hardware controller may be further based on the second digital signal being below a second threshold. The hardware controller may further determine a state of the electric vehicle. The determination by the hardware controller may be further based on the state of the electric vehicle being in an ON state. The hardware controller may be further configured to control the power switching circuit to transmit the power to the magnetic brake for a limited period of time. The apparatus may further include a power source charging/discharging circuit configured to selectively charge and discharge the power source.

The power storage device may be a supercapacitor. The hardware controller may control the power switching circuit to transmit the power to the magnetic brake until the supercapacitor discharges. The hardware controller may determine a state of a tow switch of the electric vehicle. The determination by the hardware controller may be further based on the state of the tow switch.

A system may comprise a battery; a magnetic brake; an analog-to-digital converter connected to the battery and configured to output a first digital signal representing a voltage across battery terminals of the battery; a power storage device separate from the battery; a voltage regulator configured to receive power from the battery and output power to the power storage device; a power switching circuit configured to receive power from the power storage device and output power to the magnetic brake of an electric vehicle; and a hardware controller configured to receive the first digital signal; determine, based on the digital signal, whether the voltage across the battery terminals is below a first threshold; and control, based on a determination that the voltage across the battery terminals is below the first threshold, the power switching circuit to transmit power to the magnetic brake.

The system may further include a memory configured to store mappings of voltages and threshold values. The system may further include a tow switch and the determination by the hardware controller may be based on the state of the tow switch. The hardware controller is further configured to power the magnetic brake for a duration of time. The system may further include a power source charging/discharging circuit configured to selectively charge and discharge the power source.

These and other examples are defined by the claims below.

We claim:

1. An apparatus comprising:
an analog-to-digital converter configured to be attached to a battery and output a first digital signal representing a voltage across battery terminals of the battery;
a power storage device;
a voltage regulator configured to receive power from the battery and output power to the power storage device;
a power switching circuit configured to receive power from the power storage device and output power to a magnetic brake of an electric vehicle; and
a hardware controller configured to:
receive the first digital signal;
determine, based on the first digital signal, whether the voltage across the battery terminals is below a first threshold; and
control, based on a determination that the voltage across the battery terminals is below the first threshold, the power switching circuit to transmit power to the magnetic brake.

2. The apparatus of claim 1,
wherein the analog-to-digital converter is further configured to receive a voltage being applied to the magnetic brake and output a second digital signal representing the voltage being applied to the magnetic brake, and
wherein the determination by the hardware controller is further based on the second digital signal being below a second threshold.

3. The apparatus of claim 1,
wherein the hardware controller is further configured to determine a state of the electric vehicle, and
wherein the determination by the hardware controller is further based on the state of the electric vehicle being in an ON state.

4. The apparatus of claim 1, wherein the hardware controller is further configured to control the power switching circuit to transmit the power to the magnetic brake for a limited period of time.

5. The apparatus of claim 1,
wherein the power storage device is a supercapacitor, and
wherein the hardware controller is configured to control the power switching circuit to transmit the power to the magnetic brake until the supercapacitor discharges.

6. The apparatus of claim 1,
wherein the hardware controller is further configured to determine a state of a tow switch of the electric vehicle, and
wherein the determination by the hardware controller is further based on the state of the tow switch.

7. The apparatus of claim 1, further comprising:
a power source charging/discharging circuit configured to selectively charge and discharge the power source.

8. A system comprising:
a battery;
a magnetic brake;
an analog-to-digital converter connected to the battery and configured to output a first digital signal representing a voltage across battery terminals of the battery;
a power storage device separate from the battery;
a voltage regulator configured to receive power from the battery and output power to the power storage device;
a power switching circuit configured to receive power from the power storage device and output power to the magnetic brake of an electric vehicle; and
a hardware controller configured to:
receive the first digital signal;
determine, based on the first digital signal, whether the voltage across the battery terminals is below a first threshold; and
control, based on a determination that the voltage across the battery terminals is below the first threshold, the power switching circuit to transmit power to the magnetic brake.

9. The system of claim 8, further comprising:
a memory configured to store mappings of voltages and threshold values.

10. The system of claim 8, further comprising:
a tow switch,
wherein the determination by the hardware controller is further based on a state of the tow switch.

11. The system of claim 8, wherein the hardware controller is further configured to power the magnetic brake for a duration of time.

12. The system of claim 8, further comprising:
a power source charging/discharging circuit configured to selectively charge and discharge the power source.
